(19) United States
(12) Patent Application Publication
(10) Pub. No.: US 2026/0083151 A1
(43) Pub. Date: Mar. 26, 2026

(54) METHOD FOR PREPARING DOUBLE-FILLING PINEAPPLE DAIFUKU

(71) Applicant: SAN SHU GONG FOOD CO., LTD., NEW TAIPEI CITY (TW)

(72) Inventor: MEI-YAO CHEN, NEW TAIPEI CITY (TW)

(21) Appl. No.: 19/409,677

(22) Filed: Dec. 4, 2025

Related U.S. Application Data
(63) Continuation-in-part of application No. 18/498,065, filed on Oct. 31, 2023.

(51) Int. Cl. A23G 3/54; A23G 3/34; A23G 3/42; A23G 3/48

(52) U.S. Cl. CPC A23G 3/54; A23G 3/0065; A23G 3/42; A23G 3/48

(57) ABSTRACT

A method is provided for preparing double-filling pineapple daifuku, which mainly includes, in sequence from center to outside, a first internal layer, a second internal layer enclosing the first internal layer, and an external layer enclosing the second internal layer. The first internal layer includes a pineapple filling that includes, in a part thereof, fruit pulp and is of a sticky form. The second internal layer includes a vegetable/fruit filling made of banana, mango, coconut, or taro. The external layer includes a mochi skin formed of a soft sticky rice-based material. The external layer is wrapped, with a predetermined thickness, around the second internal layer, so that the double-filling pineapple daifuku exhibits multiple flavors. The pineapple filling and the vegetable/fruit filling of the first and second internal layers create a soft and loose multilayered mouthfeel, presenting a new flavor of double fillings to thereby enhance the product value of daifuku.

### CROSS REFERENCE TO RELATED APPLICATIONS

This application is a continuation-in-part of co-pending U.S. patent application Ser. No. 18/498,065 filed on Oct. 31, 2023.

### BACKGROUND OF THE INVENTION

### (a) Technical Field of the Invention

The present invention relates to a method for preparing double-filling pineapple daifuku, and more particularly to a method for preparing double-filling pineapple daifuku, which, when eaten, creates soft and loose multilayered mouthfeel, and presents a new dual-stuffing taste.

### (b) Description of the Prior Art

Pineapple cakes recently catch the attention of general consumers and are now a popular souvenir or present. As shown in FIG. 6, a commonly available pineapple cake 1 is generally composed of a filling 11 and an outer pastry skin 12 the encloses the filling 11. The outer pastry skin 12 is made of low-gluten flour mixed with egg liquid, butter, and sugar and subsequently baked to have the filling 11 completely enclosed in the outer pastry skin 12. The traditional filling 11 of the pineapple cake 1 is generally pineapple jam or winter melon jam, so that, as being combined with the baked outer pastry skin 12, in addition to a soft and loose mouthfeel perceived when eaten, presents a sour and sweet taste with the filling.

For all brands, the known pineapple cake presents, in respect of mouthfeel, puffiness from the outer pastry skin 11 and softness from the filling 11 and has generally two flavors of tart and sweet. As such, the flavors of pineapples 1 produced by all bakery are generally identical and showing no variety, providing the general consumers with no sense of novelty, and therefore, they may not attract consumers who do not love the traditional flavors. Further, due to the reasons of being long consistent of the flavor and having no variety, the general consumers are given no much choice and as such, product competition power is affected.

In view of the above, the present invention aims to provide a double-filling pineapple daifuku, which presents a new taste of dual fillings, in order to enhance the sense of novelty for the pineapple daifuku and also to provide the pineapple daifuku with a multilayer varying taste as compared with the traditional pineapple cakes.

### SUMMARY OF THE INVENTION

The primary objective of the present invention is to provide a method for preparing double-filling pineapple daifuku, in which a pineapple filling and a vegetable/fruit stuffing filling of internal layers and a mochi skin of an external layer jointly create a soft and loose multilayered mouthfeel, presenting a new flavor of double fillings, providing the pineapple daifuku with a better layer varying mouthfeel as compared with the known pineapple cakes to thereby improve product competition power.

The double-filling pineapple daifuku comprises, in sequence from center to outside, a first internal layer, a second internal layer enclosing the first internal layer, and an external layer enclosing the second internal layer. The first internal layer comprises a pineapple filling; the second internal layer comprises a vegetable/fruit filling; and the external layer comprises a mochi skin formed of a soft sticky rice-based material, wherein the external layer is wrapped, with a predetermined thickness, around the second internal layer, so that the double-filling pineapple daifuku exhibits multiple flavors. The pineapple filling of the first internal layer is combined with the vegetable/fruit filling of the second internal layer such that when the double-filling pineapple daifuku is being eaten, the pineapple filling of the first internal layer and the vegetable/fruit filling of the second internal layer that encloses the first internal layer create a soft and loose multilayered mouthfeel, presenting a new flavor of double fillings to thereby enhance a product value of daifuku.

In the double-filling pineapple daifuku, the first internal layer comprises a pineapple filling that includes, in a part thereof, fruit pulp and is of a sticky form.

In the double-filling pineapple daifuku, the second internal layer comprises a vegetable/fruit filling made of banana, mango, coconut, or taro.

In the method for preparing double-filling pineapple daifuku, the external layer is formed by subjecting a mochi skin raw material to steps of stirring and steaming to form into a mochi skin; the first internal layer and the second internal layer are formed by separately subjecting a pineapple raw material and a vegetable/fruit raw material to steps of stirring and steaming to form into a pineapple filling and a vegetable/fruit filing, respectively; and the second internal layer and the first internal layer are formed through stuffing and wrapped with the external layer so as to form a double-filling pineapple daifuku.

In the method for preparing double-filling pineapple daifuku, the mochi skin raw material includes 10% water; 8.5% hydroxypropyl distarch phosphate; 0.065% potassium sorbate; 0.052% glycerin fatty acid ester; 0.025% xanthan gum; and 0.05% flavoring.

In the method for preparing double-filling pineapple daifuku, the step of steaming the machine skin raw material of the external layer is performed by steaming the mixed and stirred mochi skin raw material at a temperature of approximately 100° C. for approximately 20 minutes.

### BRIEF DESCRIPTION OF THE DRAWINGS

FIG. 1 is a perspective view of the present invention.

FIG. 2 is a cross-sectional view of the present invention.

FIG. 3 is a flowchart of a preparation process for a mochi skin of an external layer according to the present invention.

FIG. 4 is a flowchart of a preparation process for a double-filling pineapple daifuku according to the present invention.

FIG. 5 is a schematic view showing the present invention in a condition of being eaten.

FIG. 6 is a schematic view, partly sectioned, showing a known pineapple cake.

### DETAILED DESCRIPTION OF THE PREFERRED EMBODIMENTS

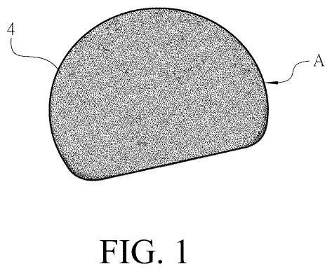

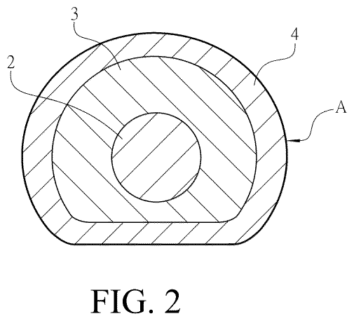

Referring jointly to FIGS. 1 and 2, which are respectively a perspective view and a cross-sectional view of the present invention, as shown in the drawings, the present invention includes, in sequence from center toward outside, a first internal layer 2, a second internal layer 3 enclosing the first internal layer 2, and an external layer 4 enclosing the second internal layer 3. The first internal layer 2 comprises a pineapple filling; the second internal layer 3 comprises a vegetable/fruit filling; and the external layer 4 comprises a mochi skin that is made of a rice-based material, such as glutinous rice, and is of a soft delicate form, wherein the second internal layer 3 is wrapped, with a predetermined thickness, around the first internal layer 2, and the external layer 4 is wrapped, with a predetermined thickness, around the second internal layer 3.

In the instant embodiment, the pineapple filling of the first internal layer 2 is made through steps of stirring and seaming a pineapple raw material to form into a pineapple stuffing that includes, in a part thereof, fruit pulp and is of a sticky form.

In the instant embodiment, the vegetable/fruit filling of the second internal layer 3 is made through steps of stirring and steaming a vegetable/fruit raw material of banana, mango, coconut, and/or taro to form into a vegetable/fruit stuffing of a sticky form.

The mochi skin of the external layer 4, which is made of a rice-based material including glutinous rice and is of a soft delicate form is completely covered with steamed and sieved potato flour.

The above-mentioned food materials are combined to form a double-filling pineapple daifuku A, so that the double-filling pineapple daifuku A is provided with a compound flavor. Further, the combination of the pineapple filling of the first internal layer 2 with the vegetable/fruit filling of the second internal layer 3 provides the double-filling pineapple daifuku A with a new favor of two fillings when it is being eaten, thereby creating a soft and loose multilayered mouthfeel, providing the pineapple daifuku with better layer varying mouthfeel as compared with the traditional pineapple cakes to therefore greatly enhance the product value of daifuku.

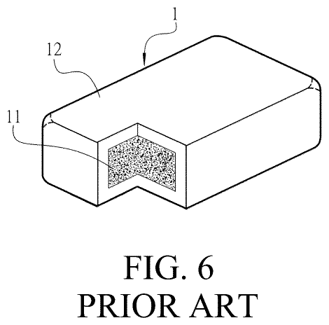

In the double-filling pineapple daifuku A according to the present invention, the external layer 4 is formed of a mochi skin that is made of a rice-based material, such as glutinous rice, and is of a soft delicate form, so that the external layer 4 combined with the pineapple filling of the first internal layer 2 and the vegetable/fruit filling of the second internal layer 3 provides, in addition to the soft and delicate mouthfeel of mochi, a mouthfeel of double fillings of pineapple and vegetable/fruit and is different from the mouthfeel of the known pineapple cake 1 shown in FIG. 6 that is achieved with an outer pastry skin 12 in combination with a filling 11, so that it may be accepted by consumers who do not love the traditional favor of the known pineapple cake 1 to allow them to taste the flavor of the pineapple cake 1.

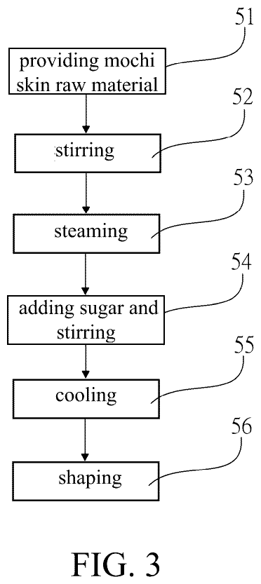

Referring to FIG. 3, which is a flowchart of a preparation process for the mochi skin of the external layer 4 according to the present invention, as shown in the drawing, the preparation process of the mochi skin of the external layer 4 of the present invention includes the following steps:
(1) providing mochi skin raw material 51, wherein the mochi skin raw material comprises: 10% water; 8.5% hydroxypropyl distarch phosphate; 0.065% potassium sorbate; 0.052% glycerin fatty acid ester; 0.025% xanthan gum; and 0.05% flavoring;
(2) stirring 52, wherein a predetermined amount of the mochi skin raw material from Step (1) is mixed and stirred;
(3) steaming 53, wherein the mixed and stirred mochi skin raw material from Step (2) is steamed at a temperature of approximately 100° C. for approximately 20 minutes;
(4) adding sugar and stirring 54, wherein the steamed mochi skin raw material from Step (3) is added with 39% maltose and 8% granulated sugar and is stirred evenly;
(5) cooling 55, wherein a semi-finished product of mochi skin obtained through adding with sugar and stirring in Step (4) is placed at room temperature to cool; and
(6) shaping 56, wherein the cooled semi-finished product is shaped to form a mochi skin.

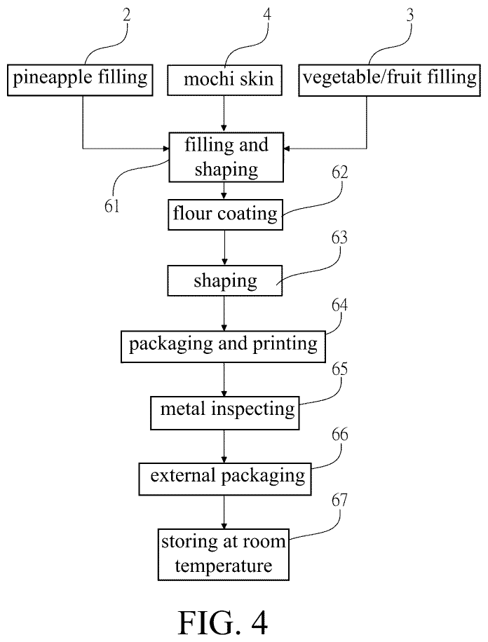

Referring to FIG. 4, which is a flowchart of a preparation process for the double-filling pineapple daifuku according to the present invention, as shown in the drawing, the preparation process of the double-filling pineapple daifuku of the present invention includes the following steps:
(1) filling and shaping 61, wherein the pineapple filling of the first internal layer 2 and the vegetable/fruit filling of the second internal layer 3 are filled into the mochi skin of the external layer 4;
(2) flour coating 62, wherein a pineapple filling daifuku semi-finished product obtained through filling and shaping of Step (1) is coated and wrapped with 1% sieved potato flour;
(3) shaping 63, wherein the pineapple filling daifuku semi-finished product from Step (2) is shaped into granular pineapple filling daifuku;
(4) packaging and printing 64, wherein the pineapple filling daifuku from Step (3) is packaged and printed with relevant product description and label;
(5) metal inspecting 65, wherein the pineapple filling daifuku product is inspected to check whether metal components are contained by using relevant instruments;
(6) external packaging 66, wherein a predetermined number of pineapple filling daifuku are packaged together; and
(7) storing at room temperature 67, wherein the packaging-completed pineapple filling daifuku is properly stored at room temperature until shipment.

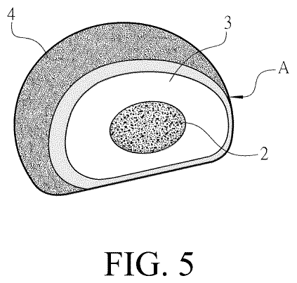

Referring to FIG. 5, which is a schematic view showing the present invention in a condition of being eaten, as shown in the drawing, a consumer, when purchasing and tasting the double-filling pineapple daifuku A, can place the external layer 4, the second internal layer 3, and the first internal layer 2 all into the mouth at the same time so that after the mochi skin of the external layer 4 and the vegetable/fruit filling of the second internal layer 3 are bitten open, the pineapple filling of the first internal layer 2, due to being a food material including, in a part thereof, fruit pulp and in a sticky form, is naturally exposed, so that when being eaten by the consumer, the vegetable/fruit filling of the second internal layer 3 that is in a sticky form is combined with the pineapple filling of the first internal layer 2 that is in a sticky form to generate a compound flavor and providing a unique new mouthfeel of double fillings, providing the double-filling pineapple daifuku A with a better layer varying mouthfeel as compared with the known pineapple cakes, thereby greatly enhancing the diet art of desserts.

Compared with the traditional dessert of pineapple cake, the present invention provides at least the following advantages:
(1) One single piece of double-filling pineapple daifuku A includes at least three food materials, including pineapple filling, vegetable/fruit filling, and rice-based material made mochi, and may enhance the diet art of desserts.
(2) One single piece of double-filling pineapple daifuku A provides a taste for stuffing of at least two flavors, and the stuffing includes the pineapple filling of the first internal layer 2 and the sticky vegetable/fruit filling of the second internal layer 3, providing a breakthrough to the flavor of the traditional daifuku and pineapple cake, and helping increasing the consumers'desire for purchases and increasing product sales.
(3) A composite flavor of pineapple in combination with various vegetable/fruit is presented, so that eating the double-filling pineapple daifuku A enables tasting a new flavor of mochi and pineapple in combination with various vegetable/fruit to thereby present a mouthfeel of double fillings, which is different from the traditional pineapple cakes.
(4) For consumers who do not love or do not accept the traditional flavor of the pineapple cakes, the present invention provides a choice of product that allows for tasting of pineapple cake flavor.

In summary, the present invention provides a double-filling pineapple daifuku that is formed of stuffing that is formed of pineapple in combination with various vegetable/fruit and an external layer formed of mochi. The pineapple filling and the vegetable/fruit filling of the internal layers, together with the mochi skin of the external layer, create a soft and loose multilayered mouthfeel, presenting a new flavor of double fillings, providing the pineapple daifuku with better layer-varying mouthfeel as compared with the known pineapple cakes, thereby enhancing the product value.

I claim:

1. A method for preparing double-filling pineapple daifuku, comprising the following steps:
providing predetermined amounts of pineapple filling raw material and vegetable/fruit filling raw material, which are separately subjected to steps of stirring and steaming to form a pineapple filling and a vegetable/fruit filling, respectively;
providing a predetermined amount of a mochi skin raw material, which is subjected to steaming;
adding the steamed mochi skin raw material with sugar and stirring evenly, and subsequently placing a sugar-added and stirred semi-finished product at room temperature to cool;
shaping the cooled semi-finished product into a mochi skin; and
stuffing the pineapple filling and the vegetable/fruit filling into the mochi skin to form a double-filling pineapple daifuku, and subjecting the double-filling pineapple daifuku to four coating and shaping.

2. The method for preparing double-filling pineapple daifuku according to claim 1, wherein the mochi skin raw material includes 10% water; 8.5% hydroxypropyl distarch phosphate; 0.065% potassium sorbate; 0.052% glycerin fatty acid ester; 0.025% xanthan gum; and 0.05% flavoring.

3. The method for preparing double-filling pineapple daifuku according to claim 1, wherein the mochi skin raw material is steamed at a temperature of approximately 100° C. for approximately 20 minutes.

4. The method for preparing double-filling pineapple daifuku according to claim 1, wherein the steamed mochi skin raw material is added with 39% maltose and 8% granulated sugar and is stirred evenly.

5. The method for preparing double-filling pineapple daifuku according to claim 1, wherein the pineapple filling comprises a filling that includes, in a part thereof, fruit pulp and is of a sticky form.

6. The method for preparing double-filling pineapple daifuku according to claim 1, wherein the vegetable/fruit filling comprises a filling made of banana, mango, coconut, or taro.
